(19) United States
(12) Patent Application Publication
(10) Pub. No.: US 2022/0343622 A1
(43) Pub. Date: Oct. 27, 2022

(54) IMAGE SEGMENTATION METHOD AND APPARATUS

(71) Applicant: Inspur Electronic Information Industry Co., Ltd., Jinan, Shandong (CN)

(72) Inventors: Li WANG, Jinan, Shandong (CN); Zhenhua GUO, Jinan, Shandong (CN); Yaqian ZHAO, Jinan, Shandong (CN)

(21) Appl. No.: 17/753,522

(22) PCT Filed: Dec. 30, 2019
(86) PCT No.: PCT/CN2019/130005

§ 371 Date: Mar. 6, 2022

(30) Foreign Application Priority Data
Sep. 6, 2019 (CN) 201910844438.0

(51) Int. Cl. G06V 10/26; G06T 7/11; G06V 10/82

(52) U.S. Cl. CPC G06V 10/26; G06T 7/11; G06V 10/82; G06T 2207/20084

(57) ABSTRACT

Provided in the present invention are an image segmentation method and apparatus. A segmented image of each target object, after parameter adjustment, in an acquired image to be segmented is determined by using a preset 3D convolutional neural network model, specifically the process comprising: extracting, by using an extraction module in the 3D convolutional neural network model, a first feature map matrix of at least one target object of the image to be segmented; adjusting, by using a pixel-level significance enhancement module, parameters of the first feature map matrix of each target object, and determining a pixel-level weighting matrix of each target object; enhancing a matrix channel of the first feature map matrix of each target object according to a channel-level significance enhancement module, and determining a channel-level weighting matrix of each target object; performing, by using a 3D residual deconvolutional module, reduction processing on the size of a target matrix of the target object, wherein the size is obtained by increasing the sum of the pixel-level weighting matrix and channel-level weighting matrix of each target object; and determining a segmented image of each target object after parameter adjustment. On the basis of the present invention, a high-precision segmented image can be obtained.

### CROSS REFERENCE TO RELATED APPLICATIONS

This application is a 371 of International Patent Application Number PCT/CN2019/130005, filed on Dec. 30, 2019, claims priority to Chinese Patent Application No. 201910844438.0, filed to the CNIPA on Sep. 6, 2019 and entitled “Image Segmentation Method and Apparatus, the entire contents of which are incorporated herein by reference.

### TECHNICAL FIELD

The present disclosure relates to the field of computer vision technology, in particular to an image segmentation method and apparatus.

### BACKGROUND

With the rapid development of society, the development of computer vision technology is also getting faster and faster, especially the image segmentation technology in the computer vision technology. Wherein image segmentation refers to the process of dividing an image into several regions with similar properties.

The existing image segmentation technology is to input an image into a traditional 2D convolutional neural network, extract a feature map of the image through a convolution operation, and then restore the extracted feature map to obtain a segmentation result, namely a segmented image. However, the precision of a segmented image obtained by segmenting an image based on a traditional 2D convolutional neural network is low.

### SUMMARY

In view of this, the purpose of the present disclosure is to provide an image segmentation method and apparatus to improve the precision of segmented images.

In order to achieve the above purpose, the present disclosure provides the following technical solutions:

a first aspect of the embodiments of the present disclosure discloses an image segmentation method, and the method includes:

acquiring an image to be segmented; and

determining, by a preset 3D convolutional neural network model, a segmented image of each target object after parameter adjustment in the image to be segmented, wherein the 3D convolutional neural network model is pre-trained based on image sample data, and the 3D convolutional neural network model includes an extraction module, a pixel-level saliency enhancement module, a channel-level saliency enhancement module and a 3D residual deconvolution module; and specifically, the process of determining, by the preset 3D convolutional neural network model, a segmented image of each target object after parameter adjustment in the image to be segmented includes:

extracting, by the extraction module, a first feature map matrix of at least one target object of the image to be segmented;

adjusting, by the pixel-level saliency enhancement module, a parameter in the first feature map matrix of each target object to determine a pixel-level weighting matrix of each target object, wherein the parameter in the first feature map matrix of each target object is the pixel of the target object;

enhancing, by the channel-level saliency enhancement module, a matrix channel in the first feature map matrix of each target object to determine a channel-level weighting matrix of each target object; and

calculating, by the 3D residual deconvolution module, the sum of the pixel-level weighting matrix and the channel-level weighting matrix of each target object to obtain a target matrix of the target object, and carrying out restoration processing on the target matrix after size increase of each target object to determine a segmented image of each target object after parameter adjustment in the image to be segmented.

Optionally, the step of adjusting, by the pixel-level saliency enhancement module, a parameter in the first feature map matrix of each target object to determine a pixel-level weighting matrix of each target object includes:

performing, by the pixel-level saliency enhancement module, dimensional transformation, dimensional adjustment and nonlinear processing on the feature map matrix of each target object to obtain a second feature map matrix of the target object; and

performing weighting summation on the first feature map matrix of each target object and the second feature map matrix of the target object to obtain a pixel-level weighting matrix of each target object.

Optionally, the step of enhancing, by the channel-level saliency enhancement module, a matrix channel in the first feature map matrix of each target object to determine a channel-level weighting matrix of each target object includes:

performing, by the channel-level saliency enhancement module, dimensional transformation, dimensional adjustment and nonlinear processing on the first feature map matrix of each target object to obtain a third feature map matrix of each target object; and

performing weighting summation on the first feature map matrix of each target object and the third feature map matrix of the target object to obtain a channel-level weighting matrix of each target object.

Optionally, the extraction module includes a convolution module and a 3D residual convolution module, and extracting, by the extraction module, a first feature map matrix of at least one target object of the image to be segmented includes:

extracting, by the convolution module, a feature map matrix of at least one target object of the image to be recognized; and

extracting, by the 3D residual convolution module, the feature map matrix of each target object to obtain a first feature map matrix of at least one target object of the image to be recognized.

A second aspect of the embodiments of the present disclosure discloses an image segmentation apparatus, and the apparatus includes:

an acquiring unit, configured to acquire an image to be segmented;

a 3D convolutional neural network model, configured to determine a segmented image of each target object after parameter adjustment in the image to be segmented, wherein the 3D convolutional neural network model is pre-trained based on image sample data, and the 3D convolutional neural network model includes an extraction module, a pixel-level saliency enhancement module, a channel-level saliency enhancement module and a 3D residual deconvolution module;

the extraction module, configured to extract a first feature map matrix of at least one target object of the image to be segmented;

the pixel-level saliency enhancement module, configured to adjust a parameter in the first feature map matrix of each target object to determine a pixel-level weighting matrix of each target object, wherein the parameter in the first feature map matrix of each target object is the pixel of the target object;

the channel-level saliency enhancement module, configured to enhance a matrix channel in the first feature map matrix of each target object to determine a channel-level weighting matrix of each target object; and

the 3D residual deconvolution module, configured to calculate the sum of the pixel-level weighting matrix and the channel-level weighting matrix of each target object to obtain a target matrix of the target object, increasing the size of the target matrix of each target object, and carry out restoration processing on the target matrix after size increase of each target object to determine a segmented image of each target object after parameter adjustment in the image to be segmented.

Optionally, a pixel-level weighting matrix determining unit includes:

a second feature map matrix determining unit, configured to perform dimensional transformation, dimensional adjustment and nonlinear processing on the feature map matrix of each target object using the pixel-level saliency enhancement module to obtain a second feature map matrix of the target object; and

a pixel-level weighting matrix determining subunit, configured to perform weighting summation on the first feature map matrix of each target object and the second feature map matrix of the target object to obtain a pixel-level weighting matrix of each target object.

Optionally, a channel-level weighting matrix determining unit includes:

a third feature map matrix determining unit, configured to perform dimensional transformation, dimensional adjustment and nonlinear processing on the first feature map matrix of each target object using the channel-level saliency enhancement module to obtain a third feature map matrix of each target object; and

a channel-level weighting matrix determining subunit, configured to perform weighting summation on the first feature map matrix of each target object and the third feature map matrix of the target object to obtain a channel-level weighting matrix of each target object.

Optionally, the extraction module includes:

a convolution module, configured to extract a feature map matrix of at least one target object of the image to be recognized; and

a 3D residual convolution module, configured to extract the feature map matrix of each target object to obtain a first feature map matrix of at least one target object of the image to be recognized.

The present disclosure provides an image segmentation method and apparatus. The image segmentation method includes: acquiring an image to be segmented, and determining, by a preset 3D convolutional neural network model, a segmented image of each target object after parameter adjustment in the image to be segmented, wherein the 3D convolutional neural network model includes an extraction module, a pixel-level saliency enhancement module, a channel-level saliency enhancement module and a 3D residual deconvolution module; and specifically, the process of determining, by the preset 3D convolutional neural network model, a segmented image of each target object after parameter adjustment in the image to be segmented includes: extracting, by the extraction module, a first feature map matrix of at least one target object of the image to be segmented; adjusting, by the pixel-level saliency enhancement module, a parameter in the first feature map matrix of each target object to determine a pixel-level weighting matrix of each target object, wherein the parameter in the first feature map matrix of each target object is the pixel of the target object; enhancing, by the channel-level saliency enhancement module, a matrix channel in the first feature map matrix of each target object to determine a channel-level weighting matrix of each target object; and calculating, by the 3D residual deconvolution module, the sum of the pixel-level weighting matrix and the channel-level weighting matrix of each target object to obtain a target matrix of the target object, increasing the size of the target matrix of each target object, and carrying out restoration processing on the target matrix after size increase of each target object to determine a segmented image of each target object after parameter adjustment in the image to be segmented. According to the technical solution provided by the present disclosure, by determining a segmented image of each target object after parameter adjustment in the image to be segmented using the preset 3D convolutional neural network model, a high-precision segmented image can be obtained.

### BRIEF DESCRIPTION OF THE DRAWINGS

In order to more clearly describe the embodiments of the present disclosure or the technical solutions in the prior art, the accompanying drawings that need to be used in the embodiments or the description of the prior art will be briefly introduced below. Apparently, the accompanying drawings in the following description are only embodiments of the present disclosure. For those of ordinary skill in the art, other accompanying drawings can be obtained based on these accompanying drawings without creative work.

FIG. 1 is a schematic flowchart of an image segmentation method according to an embodiment of the present disclosure;

FIG. 2 is a schematic flowchart of a method for determining a segmented image of each target object after parameter adjustment in an image to be segmented using a preset 3D convolutional neural network model according to an embodiment of the present disclosure;

FIG. 3 is a structural schematic diagram of a Unet network structure according to an embodiment of the present disclosure; and

FIG. 4 is a structural schematic diagram of an image segmentation apparatus according to an embodiment of the present disclosure.

### DETAILED DESCRIPTION

The technical solutions in the embodiments of the present disclosure will be clearly and completely described below with reference to the accompanying drawings in the embodiments of the present disclosure. Apparently, the described embodiments are only a part of the embodiments of the present disclosure, but not all of the embodiments. Based on the embodiments of the present disclosure, all other embodiments obtained by those of ordinary skill in the art without creative labor fall within the scope of protection of the present disclosure.

In this application, the terms “including”, “include” or any other variants thereof are intended to cover non-exclusive inclusion, so that a process, method, article or apparatus including a series of elements not only includes those elements, but also includes other elements that are not explicitly listed, or further includes the elements inherent to this process, method, article or apparatus. Without further limitation, an element preceded by the phrase “including a . . . ” does not preclude the presence of additional identical elements in a process, method, article or apparatus that includes the element.

As can be seen from the above background technology, the existing image segmentation technology is to input an image into a traditional 2D convolutional neural network, extract a feature map of the image through a convolution operation, and then restore the extracted feature map to obtain a segmentation result, namely a segmented image. However, the precision of a segmented image obtained by segmenting an image based on a traditional 2D convolutional neural network is low. The existing image segmentation technology can also input an image into a traditional 3D convolutional neural network, extract a feature map of the image through a convolution operation, and then restore the extracted feature map to obtain a segmentation result, namely a segmented image. Although a traditional 3D convolutional neural network can utilize the time series information of a video, the precision of a segmented image obtained by segmenting an image based on a traditional 3D convolutional neural network is low.

Therefore, the embodiments of the present disclosure provide an image segmentation method and apparatus. On the basis of an existing traditional 3D convolutional neural network, a pixel-level saliency enhancement module and a channel-level saliency enhancement module are added, the parameters in a first feature map matrix of each target object are adjusted by the pixel-level saliency enhancement module, and a matrix channel in the first feature map matrix of each target object is enhanced by the channel-level saliency enhancement module, thus a weighting matrix with a better segmentation effect can be obtained, then the size of a target matrix of each target object is increased by the 3D residual deconvolution module, and restoration processing is carried out on the target matrix after size increase of each target object, so that a high-precision segmented image can be obtained.

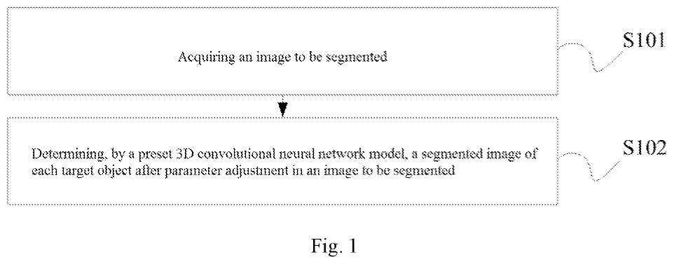

Referring to FIG. 1 which is a schematic flowchart of an image segmentation method according to an embodiment of the present disclosure, and the image segmentation method includes the following steps:

S101: acquiring an image to be segmented.

During the specific execution of step S101, a single image to be segmented can be obtained, or N consecutive images to be segmented can be obtained, wherein N is a positive integer greater than or equal to 1.

It should be noted that the acquired image to be segmented may be a grayscale image or a color image.

S102: determining, by a preset 3D convolutional neural network model, a segmented image of each target object after parameter adjustment in an image to be segmented.

In the embodiment of the present disclosure, the 3D convolutional neural network model is obtained by pre-training based on image sample data. The specific training process is as follows: obtaining at least one image sample, wherein each image sample in the at least one image sample includes corresponding image sample data, inputting the image sample data of each image sample into a 3D convolutional neural network model to be trained to obtain a predicted segmented image of the image sample by the 3D convolutional neural network model to be trained, and updating the parameters in the 3D convolutional neural network model to be trained with the predicted segmented image approaching a target segmented image as the training target until the 3D convolutional neural network model to be trained converges, thus the 3D convolutional neural network model is obtained.

It should be noted that the 3D convolutional neural network model includes an extraction module, a pixel-level saliency enhancement module, a channel-level saliency enhancement module and a 3D residual deconvolution module.

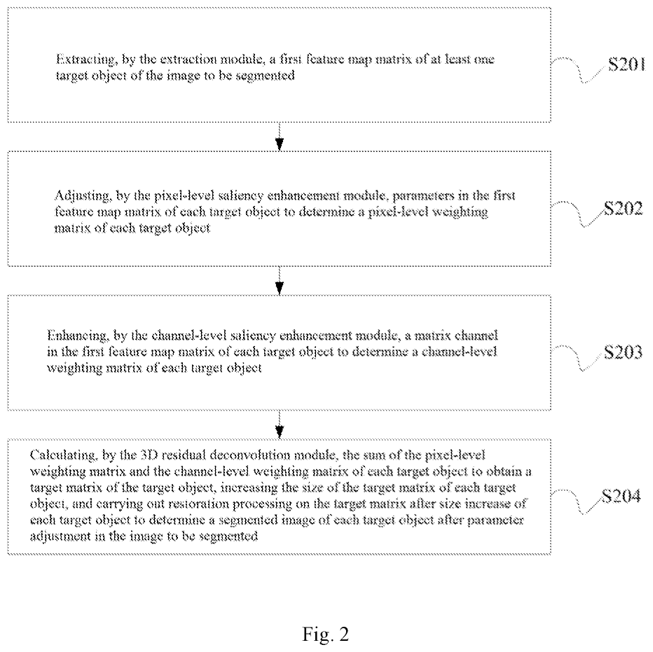

Specifically, the process of determining, by a preset 3D convolutional neural network model, a segmented image of each target object after parameter adjustment in the image to be segmented is shown in FIG. 2, and includes the following steps:

S201: extracting, by the extraction module, a first feature map matrix of at least one target object of the image to be segmented.

It should be noted that the extraction module includes a convolution module and a 3D residual convolution module.

During the specific execution of step S201, the feature map matrix of at least one target object of the image to be segmented is extracted by the convolution module, and a feature matrix of each target object is extracted by the 3D residual convolution module to obtain the first feature map matrix of at least one target object of the image to be segmented.

It should be noted that the convolution module includes a 3D convolution layer, a batch normalization layer and an activation function layer; the 3D residual convolution module includes a first batch normalization layer, a first activation function layer, a first 3D convolution layer, a second batch normalization layer, a second activation function layer, a second 3D convolution layer, a third 3D convolution layer and an Add layer.

In order to better understand the above content, an example is given below.

For example, an image to be segmented with a height of h, a width of w and a thickness of z is acquired. For ease of understanding, acquiring one image to be segmented is taken as an example.

Firstly, when the height of the acquired single image to be segmented is h, the width is w, and the thickness is z, the acquired image to be segmented is sequentially input into the 3D convolution layer conv3d with the convolution kernel having dimension of 3×3×3×kernel_size, the batch normalization layer BN with the convolution kernel having dimension of h×w×z×kernel_size and the activation function layer Relu with the convolution kernel having dimension of h×w×z×kernel_size in the convolution module with the number of channels being CHANNEL to extract the feature map matrix, and the feature map matrix of the target object with the number of channels of kernel_size is obtained, wherein the height of the feature map matrix of the target object is h, the width is w, and the thickness is z.

Secondly, the obtained feature map matrix of the target object with the number of channels of kernel_size is input into the first batch normalization layer BN1, the first activation function layer Relu1, the 3×3×3×kernel_size first 3D convolution layer conv3d1, the second batch normalization layer BN2, the second activation function layer Relu2, the 3×3×3×kernel_size second 3D convolution layer conv3d2 in the 3D residual convolution module with the number of channels, to obtain a first result matrix with a height of h/2, a width of w/2 and a thickness of z/2 and with the number of channels of kernel_size.

Thirdly, the obtained feature map matrix of the target object with the number of channels of kernel_size is input into the third 3D convolution layer conv3d2 in the 3D residual convolution module with the number of channels to obtain a second result matrix with a height of h/2, a width of w/2 and a thickness of z/2 and with the number of channels of kernel_size.

Finally, the first result matrix and the second result matrix are input into the Add layer to obtain the first feature map matrix of the target object with the number of channels of kernel_size, wherein the height of the first feature map matrix of the target object is h/2, the width is w/2, the thickness is z/2, that is, after the image to be segmented with the height of h, the width of w and the thickness of z is processed by the convolution module and the 3D residual convolution module, the first feature map matrix of at least one target object is obtained as (h/2)×(w/2)×(z/2)×kernel_size.

It should be noted that CHANNEL represents both the number of channels and the number of target objects. The specific value of the channel can be set by the inventor according to his/her own needs, which is not limited in the embodiment of the present disclosure.

It should be noted that every time after the feature map matrix of the target object is further extracted by a 3D residual convolution module, the height, width and thickness of the obtained first feature map matrix of the target object are reduced to half of the original height, width and thickness, and the number of channels of the first feature map matrix of the target object is several times or even dozens of times the original number of channels. For example, when the preset 3D convolutional neural network includes one 3D residual convolution module, after processing by the 3D residual convolution module, the height, width and thickness of the first feature map matrix of the target object are reduced to half of the original height, width and thickness, and when the preset 3D convolutional neural network includes two 3D residual convolution modules, after processing by the two 3D residual convolution modules, the height, width and thickness of the first feature map matrix of the target object are reduced to a quarter of the original height, width and thickness.

The above description is only the preferred way of the number of the 3D residual convolution modules in the preset 3D convolutional neural network provided by the embodiment of this application. Specifically, the number can be set by the inventor according to his/her own needs, which is not limited in the embodiment of the present disclosure.

S202: adjusting, by the pixel-level saliency enhancement module, parameters in the first feature map matrix of each target object to determine a pixel-level weighting matrix of each target object.

Wherein the parameters in the first feature map matrix of each target object are the pixels of each target object.

During the specific execution of step S202, dimensional transformation, dimensional adjustment and nonlinear processing are carried out on the first feature map matrix of each target object using the pixel-level saliency enhancement module to obtain a second feature map matrix of the target object, and weighting summation is carried out on the first feature map matrix of each target object and the second feature map matrix of the target object to obtain the pixel-level weighting matrix of each target object.

In order to better understand the above content, an example is given below.

For example, an image to be segmented with a height of h, a width of w and a thickness of z is acquired. For ease of understanding, acquiring one image to be segmented is taken as an example.

After the image to be segmented with the height of h, the width of w and the thickness of z is processed by the convolution module and the 3D residual convolution module of the extraction module, a feature map matrix of at least one target object with a first feature map matrix of (h/2)×(w/2)×(z/2)×kernel_size is obtained.

A1. Convolving (h/2)×(w/2)×(z/2)×kernel_size through the 3×3×3×kernel_size convolution layer of the pixel-level saliency enhancement module to obtain a h×w×z×kernel_size feature map matrix, wherein h represents height, w represents width, z represents thickness, and kernel_size represents the number of channels, and also the number of target objects.

A2. Performing dimensional transformation on the h×w×z×kernel_size feature map matrix to obtain a batchsize×t×kernel_size feature map matrix, specifically, traversing the h×w×z of the target object through the feature map matrix of h×w×z×kernel_size according to batchsize and kernel_size, and expanding h×w×z into a one-dimensional high-dimensional column vector to obtain a batchsize×t×kernel_size feature map matrix, wherein t=h×w×z.

It should be noted that since the number of the acquired images to be segmented is 1, batchsize is 1, and further batchsize×t×kernel_size is equal to t×kernel_size.

A3. Adjusting the dimension of the t×kernel_size feature map matrix to obtain a kernel_size×t feature map matrix.

A4. Multiplying the kernel_size×t feature map matrix by the t×kernel_size feature map matrix to obtain a txt feature map matrix.

It should be noted that in the process of multiplying the kernel_size×t feature map matrix by the t×kernel_size feature map matrix, if batchsize is a positive integer greater than 1, matrixes in the batchsize×kernel_size×t feature map matrix need to be multiplied by matrixes in the batchsize×t×kernel_size feature map matrix in one-to-one correspondence.

A5. Performing nonlinear mapping on the txt feature map matrix through an activation function to obtain a nonlinear txt feature map matrix.

A6. Performing dimensional transformation on the feature map matrix of at least one target object with the first feature map matrix of (h/2)×(w/2)×(z/2)×kernel_size, specifically, traversing (h/2)×(w/2)×(z/2) of the target object according to batchsize and kernel_size, and expanding (h/2)×(w/2)×(z/2) into a one-dimensional high-dimensional column vector to obtain a batchsize×t1×kernel_size feature map matrix, wherein t1=(h/2)×(w/2)×(z/2), and batchsize is equal to 1.

A7. Performing dimensional transformation on t1 and kernel_size in t1×kernel_size to obtain a kernel_size×t1 feature map matrix.

A8. Multiplying the kernel_size×t1 feature map matrix by the nonlinear txt feature map matrix to obtain a kernel_size×t feature map matrix.

It should be noted that in the process of multiplying the kernel_size×t1 feature map matrix by the nonlinear txt feature map matrix, if batchsize is a positive integer greater than 1, matrixes in the batchsize×kernel_size×t1 feature map matrix need to be multiplied by matrixes in the batchsize×t×1 feature map matrix in one-to-one correspondence.

A9. Restoring the kernel_size×t feature map matrix to obtain a kernel_sizet×h×w×z feature map matrix.

A10. Performing dimensional transformation on the kernel_sizet×h×w×z feature map matrix to obtain a h×w×z×kernel_sizet feature map matrix.

A11. Performing weighting summation on the kernel_sizet×h×w×z feature map matrix and the feature map matrix of at least one target object with the first feature map matrix of (h/2)×(w/2)×(z/2)×kernel_size with a weighting weight of alpha*(step10.result)+input, that is, adjusting the pixels in the first feature map matrix of each target object to obtain a pixel-level weighting matrix of h1×w1×z1×kernel_sizet of at least one target object, wherein kernel_sizet is the number of target objects.

S203: enhancing, by the channel-level saliency enhancement module, a matrix channel in the first feature map matrix of each target object to determine a channel-level weighting matrix of each target object.

During the specific execution of step S203, dimensional transformation, dimensional adjustment and nonlinear processing are carried out on the first feature map matrix of each target object through the channel-level saliency enhancement module to obtain a third feature map matrix of each target object, and weighting summation is carried out on the first feature map matrix of each target object and the third feature map matrix of the target object to obtain the channel-level weighting matrix of each target object.

In order to better understand the above content, an example is given below.

For example, an image to be segmented with a height of h, a width of w and a thickness of z is acquired. For ease of understanding, acquiring an image to be segmented is taken as an example.

After the image to be segmented with the height of h, the width of w and the thickness of z is processed by the convolution module and the 3D residual convolution module of the extraction module, a feature map matrix of at least one target object with the first feature map matrix of (h/2)×(w/2)×(z/2)×kernel_size is obtained, wherein kernel_size is the number of target objects.

B1. Convolving the (h/2)×(w/2)×(z/2)×channel_size first feature map matrix through a 3×3×3×channel_size convolution layer of the channel-level saliency enhancement module to obtain a h×w×z×channel_size feature map matrix, wherein h represents height, w represents width, z represents thickness, and channel_size represents the number of channels, and also the number of target objects.

B2. Performing dimensional transformation on the h×w×z×channel_size feature map matrix to obtain a batchsize×t×channel_size feature map matrix, specifically, traversing the h×w×z of the target object through the feature map matrix of batchsize×h×w×z×channel_size according to batchsize and channel_size, and expanding h×w×z into a one-dimensional high-dimensional column vector to obtain a batchsize×t×channel_size feature map matrix, wherein t=h×w×z.

It should be noted that since the number of the acquired images to be segmented is 1, batchsize is 1, and further batchsize×t×channel_size is equal to t×channel_size.

B3. Performing dimensional transformation on the (h/2)×(w/2)×(z/2)×kernel_size first feature map matrix to obtain a batchsize×t1×channel_size feature map matrix, specifically, traversing the (h/2)×(w/2)×(z/2) of the target object through the batchsize×(h/2)×(w/2)×(z/2)×kernel_size first feature map matrix according to batchsize and channel_size, and expanding (h/2)×(w/2)×(z/2) into a one-dimensional high-dimensional column vector to obtain a batchsize×t1×channel_size feature map matrix, wherein t=h×w×z.

It should be noted that since the number of the acquired images to be segmented is 1, batchsize is 1, and further batchsize×t1×channel_size is equal to t1×channel_size.

B4. Performing dimensional transformation on the t1×channel_size feature map matrix to obtain a channel_size×t1 feature map matrix.

B5. Multiplying the t1×channel_size feature map matrix by the channel_size×t1 feature map matrix to obtain a channel_size×channel_size feature map matrix.

It should be noted that in the process of multiplying the t1×channel_size feature map matrix by the channel_size×t1 feature map matrix, if batchsize is a positive integer greater than 1, matrixes in the batchsize×channel_size×t1 feature map matrix need to be multiplied by matrixes in the batchsize×t1×channel_size feature map matrix in one-to-one correspondence.

B6. Traversing the h×w×z of the target object through the channel_size×channel_size feature map matrix according to batchsize and channel_size, expanding h×w×z into a one-dimensional high-dimensional column vector, and performing a pooling operation on the high-dimensional column vector, that is, changing the vector of each channel_size dimension into a floating-point number to obtain a channel_size×1 feature map matrix.

It should be noted that the pooling operation may be a maxpoolling operation or an averagePooling operation. The inventor can make settings according to requirements, which is not limited in the embodiment of the present disclosure.

B7. Performing nonlinear mapping on the channel_size×1 feature map matrix through an activation function to obtain a nonlinear channel_size×1 feature map matrix.

It should be noted that the activation function of the channel-level saliency enhancement module may be a sigmoid function. The inventor can make selections according to actual needs, which is not limited in the embodiment of the present disclosure.

B8. Multiplying the nonlinear channel_size×1 feature map matrix by the channel_size×channel_size feature map matrix to obtain a channel_size×channel_size feature map matrix.

It should be noted that in the process of multiplying the nonlinear channel_size×1 feature map matrix by the channel_size×channel_size feature map matrix, elements (parameters) in the channel_size×1 feature map matrix need to be multiplied by elements (parameters) in the channel_size×channel_size feature map matrix in one-to-one correspondence.

B9. Multiplying the channel_size×channel_size feature map matrix by the t×channel_size feature map matrix to obtain a channel_size×t feature map matrix, wherein the channel_size×t feature map matrix is a three-dimensional feature map matrix.

It should be noted that in the process of multiplying the channel_size×channel_size feature map matrix by the t×channel_size feature map matrix, if batchsize is a positive integer greater than 1, matrixes in the batchsize×channel_size×channel_size feature map matrix need to be multiplied by matrixes in the batchsize×t×channel_size feature map matrix in one-to-one correspondence.

B10. Traversing the h×w×z of the target object through the channel_size×t feature map matrix according to batchsize and channel_size, expanding h×w×z into a t-dimensional high-dimensional column vector, and performing a pooling operation on the high-dimensional column vector, that is, changing the vector of each channel_size dimension into a floating-point number to obtain a channel_size×1 feature map matrix.

B11. Performing nonlinear mapping on the channel_size×1 feature map matrix through an activation function to obtain a nonlinear channel_size×1 feature map matrix.

It should be noted that the activation function of the channel-level saliency enhancement module may be a sigmoid function. The inventor can make selections according to actual needs, which is not limited in the embodiment of the present disclosure.

B12. Multiplying the nonlinear channel_size×1 feature map matrix by the channel_size×t feature map matrix to obtain a channel_size×t feature map matrix.

It should be noted that in the process of multiplying the nonlinear channel_size×1 feature map matrix by the channel_size×t feature map matrix, elements (parameters) in the channel_size×1 feature map matrix need to be multiplied by elements (parameters) in the channel_size×t feature map matrix in one-to-one correspondence.

B13. Performing dimensional transformation on the channel_size×t feature map matrix, and restoring t to h×w×z to obtain a channel_size×h×w×z feature map matrix.

B14. Performing dimensional interchange on the channel_size×h×w×z feature map matrix to obtain a h×w×z×channel_size feature map matrix.

B15. Performing weighting summation on the h×w×z×channel_size feature map matrix and the feature map matrix of at least one target object with the first feature map matrix of (h/2)×(w/2)×(z/2)×kernel_size with a weighting weight of beta*(step15.result)+input, that is, enhancing matrix channels in the first feature map matrix of each target object to obtain a channel-level weighting matrix of h1×w1×z1×channel_size of at least one target object, wherein channel_size is the number of target objects.

Further, in the process of performing step S202 and step S203, step S202 and step S203 can be performed simultaneously, or step S202 can be performed followed by step S203. The execution sequence of step S202 and step S203 can be set by the inventor according to his/her own needs, which is not limited in the embodiment of the present disclosure.

S204: calculating, by the 3D residual deconvolution module, the sum of the pixel-level weighting matrix and the channel-level weighting matrix of each target object to obtain a target matrix of the target object, increasing the size of the target matrix of each target object, and carrying out restoration processing on the target matrix after size increase of each target object to determine a segmented image of each target object after parameter adjustment in the image to be segmented.

It should be noted that the 3D residual deconvolution module includes a deconvolution Deconv3d layer, a conv3d1 layer, a BN1 layer, a Relu1 layer, a BN2 layer, a Relu2 layer, a conv3d2 layer, a BN2 layer, a Relu3 layer, a conv3d3 layer and an add layer.

In the specific process of performing step S204, the sum of the pixel-level weighting matrix and the channel-level weighting matrix of each target object is calculated to obtain the target matrix of the target object, and the target matrix is sequentially input into the deconvolution Deconv3d layer, the conv3d1 layer, the BN1 layer and the Relu1 layer for processing to obtain a first matrix, the first matrix is sequentially input into the BN2 layer, the Relu2 layer, the conv3d2 layer, the BN2 layer, the Relu3 layer and the conv3d3 layer for processing to obtain a second matrix, the first matrix and the second matrix are input into the Add layer for processing, the size of the target matrix of each target object is increased, and restoration processing is carried out on the target matrix after size increase of each target object to determine the segmented image of each target object after parameter adjustment in the image to be segmented.

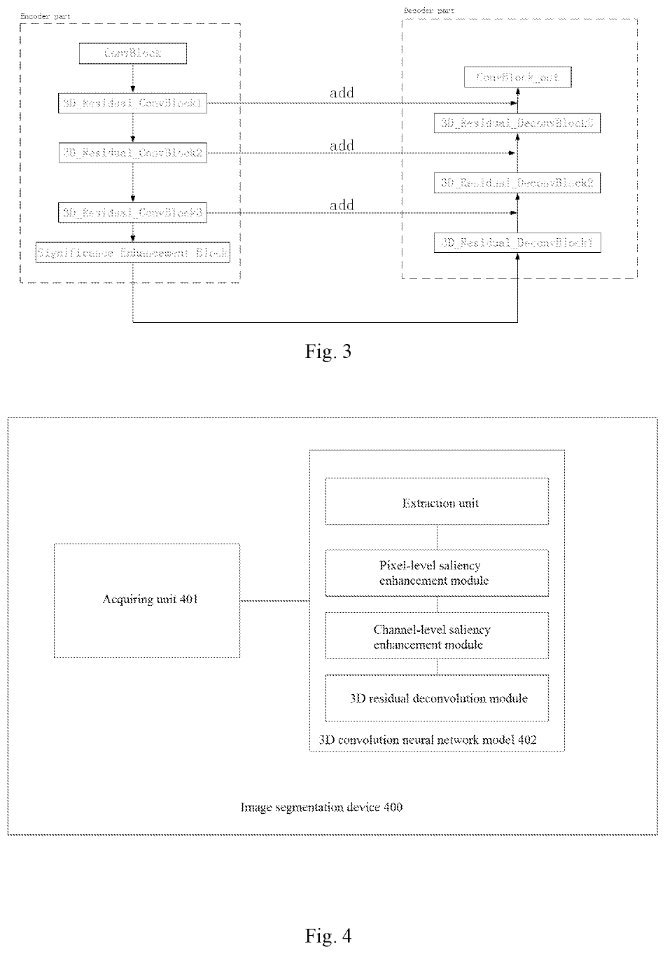

Further, in the embodiment of the present disclosure, when the 3D convolutional neural network model includes one 3D residual convolution module, the 3D convolutional neural network model correspondingly includes one 3D residual deconvolution module. When the 3D convolutional neural network model includes three 3D residual convolution modules, the 3D convolutional neural network correspondingly includes three 3D residual deconvolution modules. For example, when the 3D convolutional neural network model is a Unet network structure, as shown in FIG. 3, the Unet network structure includes two parts, namely an Encoder and a Decoder. The Encoder includes a convolution module ConvBlock, three residual convolution modules 3D_Residual_ConvBlock, a pixel-level saliency enhancement module and a channel-level saliency enhancement module Saliency Enhancement Block, the Decoder includes three residual deconvolution modules 3D_Residual_DeConvBlock corresponding to the three residual convolution modules 3D_Residual_ConvBlock, and a ConvBlock_Out. In the process of processing the weighting matrix of each target object through the 3D residual deconvolution modules, every time after one 3D residual deconvolution module is used to calculate the sum of the pixel-level weighting matrix and the channel-level weighting matrix of each target object to obtain the target matrix of the target object and increase the size of the target matrix of each target object, the target matrix after size increase and the output of the corresponding 3D residual convolution module are combined and input into the next 3D residual deconvolution module until the output of the last 3D residual deconvolution module is combined with the output of the corresponding 3D residual convolution module, the result is input into the ConvBlock_Out to further increase the size of the target matrix of each target object, and restoration processing is carried out on the target matrix after size increase of each target object to determine the segmented image of each target object after parameter adjustment in the image to be segmented.

The present disclosure provides an image segmentation method and apparatus. The image segmentation method includes: acquiring an image to be segmented, inputting the image to be segmented into a 3D convolutional neural network model, and determining a segmented image of each target object after parameter adjustment in the image to be segmented through the preset 3D convolutional neural network model, wherein the process of determining a segmented image of each target object after parameter adjustment in the image to be segmented through the preset 3D convolutional neural network model specifically includes: extracting, by an extraction module, a first feature map matrix of at least one target object of the image to be segmented; adjusting, by a pixel-level saliency enhancement module, the parameters in the first feature map matrix of each target object to determine a pixel-level weighting matrix of each target object, wherein the parameters in the first feature map matrix of each target object are the pixels of the target object; enhancing, by the channel-level saliency enhancement module, a matrix channel in the first feature map matrix of each target object to determine a channel-level weighting matrix of each target object; and calculating, by a 3D residual deconvolution module, the sum of the pixel-level weighting matrix and the channel-level weighting matrix of each target object to obtain a target matrix of the target object, increasing the size of the target matrix of each target object, and carrying out restoration processing on the target matrix after size increase of each target object to determine a segmented image of each target object after parameter adjustment in the image to be segmented. According to the technical solution provided by the present disclosure, by determining a segmented image of each target object after parameter adjustment in the image to be segmented through the preset 3D convolutional neural network model, a high-precision segmented image can be obtained.

Based on the image segmentation method disclosed in the embodiment of the present disclosure, the embodiment of the present disclosure further discloses an image segmentation apparatus correspondingly. As shown in FIG. 4, the image segmentation apparatus 400 includes:

an acquiring unit 401, configured to acquire an image to be segmented;

a 3D convolutional neural network model 402, configured to determine a segmented image of each target object after parameter adjustment in the image to be segmented, wherein the 3D convolutional neural network model is pre-trained based on image sample data, and the 3D convolutional neural network model includes an extraction module, a pixel-level saliency enhancement module, a channel-level saliency enhancement module and a 3D residual deconvolution module;

the extraction module, configured to extract a first feature map matrix of at least one target object of the image to be segmented;

the pixel-level saliency enhancement module, configured to adjust the parameters in the first feature map matrix of each target object to determine a pixel-level weighting matrix of each target object, wherein the parameters in the first feature map matrix of each target object are the pixels of the target object;

the channel-level saliency enhancement module, configured to enhance a matrix channel in the first feature map matrix of each target object to determine a channel-level weighting matrix of each target object; and

the 3D residual deconvolution module, configured to calculate the sum of the pixel-level weighting matrix and the channel-level weighting matrix of each target object to obtain a target matrix of the target object, increase the size of the target matrix of each target object, and carry out restoration processing on the target matrix after size increase of each target object to determine a segmented image of each target object after parameter adjustment in the image to be segmented.

The present disclosure provides an image segmentation apparatus, wherein an image to be segmented is acquired by an acquiring unit, and a segmented image of each target object after parameter adjustment in the image to be segmented is determined by a preset 3D convolutional neural network model, wherein the 3D convolutional neural network model includes an extraction module, a pixel-level saliency enhancement module, a channel-level saliency enhancement module and a 3D residual deconvolution module; a first feature map matrix of at least one target object of the image to be segmented is extracted by the extraction module, the parameters in the first feature map matrix of each target object are adjusted by the pixel-level saliency enhancement module to determine a pixel-level weighting matrix of each target object, a matrix channel in the first feature map matrix of each target object is enhanced by the channel-level saliency enhancement module to determine a channel-level weighting matrix of each target object, and the sum of the pixel-level weighting matrix and the channel-level weighting matrix of each target object are calculated by the 3D residual deconvolution module to obtain a target matrix of the target object, the size of the target matrix of each target object is increased, and restoration processing is carried out on the target matrix after size increase of each target object to determine a segmented image of each target object after parameter adjustment in the image to be segmented. According to the technical solution provided by the present disclosure, by determining a segmented image of each target object after parameter adjustment in the image to be segmented through the preset 3D convolutional neural network model, a high-precision segmented image can be obtained.

Optionally, a pixel-level weighting matrix determining unit includes:

a second feature map matrix determining unit, configured to perform dimensional transformation, dimensional adjustment and nonlinear processing on the feature map matrix of each target object using the pixel-level saliency enhancement module to obtain a second feature map matrix of the target object; and

a pixel-level weighting matrix determining subunit, configured to perform weighting summation on the first feature map matrix of each target object and the second feature map matrix of the target object to obtain a pixel-level weighting matrix of each target object.

Optionally, a channel-level weighting matrix determining unit includes:

a third feature map matrix determining unit, configured to perform dimensional transformation, dimensional adjustment and nonlinear processing on the first feature map matrix of each target object using the channel-level saliency enhancement module to obtain a third feature map matrix of each target object; and

a channel-level weighting matrix determining subunit, configured to perform weighting summation on the first feature map matrix of each target object and the third feature map matrix of the target object to obtain a channel-level weighting matrix of each target object.

Optionally, the extraction module includes:

a convolution module, configured to extract a feature map matrix of at least one target object of the image to be recognized; and

a 3D residual convolution module, configured to extract the feature map matrix of each target object to obtain a first feature map matrix of at least one target object of the image to be recognized.

The embodiments in this description are described in a progressive manner, the same and similar parts between the various embodiments can be referred to each other, and each embodiment focuses on the differences from other embodiments. Especially for the system or the system embodiment, since it is basically similar to the method embodiment, the description is relatively simple, and related parts can refer to the description of the method embodiment section. The system and system embodiment described above are only illustrative, wherein the units described as separate components may or may not be physically separated, and the components shown as units may or may not be physical units, that is, the components may be located in one place, or may be distributed to multiple network units. Some or all of the modules can be selected according to actual needs to achieve the objects of the solutions of the embodiments. Those of ordinary skill in the art can understand and implement without creative work.

Those of ordinary skill in the art may further realize that the units and algorithm steps of each example described in conjunction with the embodiments disclosed herein can be implemented in electronic hardware, computer software or a combination of electronic hardware and computer software. In order to clearly illustrate the interchangeability of hardware and software, the components and steps of each example have been generally described in terms of functions in the foregoing description. Whether these functions are performed in hardware or software depends on the specific application and design constraints of the technical solutions. Professionals may implement the described functionality using different methods for each particular application, but such implementations should not be considered beyond the scope of this application.

The above description of the disclosed embodiments enables any person skilled in the art to implement or use this application. Various modifications to these embodiments are apparent to those skilled in the art, and the general principles defined herein may be implemented in other embodiments without departing from the spirit or scope of this application. Therefore, this application is not intended to be limited to the embodiments shown herein, but is to be accorded the widest scope consistent with the principles and novel features disclosed herein.

The above embodiments are only the preferred embodiments of this application. It should be pointed out that those of ordinary skill in the art can make several improvements and modifications without departing from the principles of this application, and these improvements and modifications should also be regarded as falling within the protection scope of this application.

1. An image segmentation method, comprising:
acquiring an image to be segmented; and
determining, by a preset 3D convolutional neural network model, a segmented image of each target object after parameter adjustment in the image to be segmented, wherein the 3D convolutional neural network model is pre-trained based on image sample data, and the 3D convolutional neural network model comprises an extraction module, a pixel-level saliency enhancement module, a channel-level saliency enhancement module and a 3D residual deconvolution module; and specifically, the process of determining, by the preset 3D convolutional neural network model, a segmented image of each target object after parameter adjustment in the image to be segmented comprises:
extracting, by the extraction module, a first feature map matrix of at least one target object of the image to be segmented;
adjusting, by the pixel-level saliency enhancement module, a parameter in the first feature map matrix of each target object to determine a pixel-level weighting matrix of each target object, wherein the parameter in the first feature map matrix of each target object is the pixel of the target object;
enhancing, by the channel-level saliency enhancement module, a matrix channel in the first feature map matrix of each target object to determine a channel-level weighting matrix of each target object; and
calculating, by the 3D residual deconvolution module, the sum of the pixel-level weighting matrix and the channel-level weighting matrix of each target object to obtain a target matrix of the target object, increasing the size of the target matrix of each target object, and carrying out restoration processing on the target matrix after size increase of each target object to determine a segmented image of each target object after parameter adjustment in the image to be segmented.

2. The method according to claim 1, wherein, the step of adjusting, by the pixel-level saliency enhancement module, a parameter in the first feature map matrix of each target object to determine a pixel-level weighting matrix of each target object comprises:
performing, by the pixel-level saliency enhancement module, dimensional transformation, dimensional adjustment and nonlinear processing on the feature map matrix of each target object to obtain a second feature map matrix of the target object; and
performing weighting summation on the first feature map matrix of each target object and the second feature map matrix of the target object to obtain a pixel-level weighting matrix of each target object.

3. The method according to claim 1, wherein, the step of enhancing,
by the channel-level saliency enhancement module, a matrix channel in the first feature map matrix of each target object to determine a channel-level weighting matrix of each target object comprises:
performing, by the channel-level saliency enhancement module, dimensional transformation, dimensional adjustment and nonlinear processing on the first feature map matrix of each target object to obtain a third feature map matrix of each target object; and
performing weighting summation on the first feature map matrix of each target object and the third feature map matrix of the target object to obtain a channel-level weighting matrix of each target object.

4. The method according to claim 1, wherein, the extraction module comprises a convolution module and a 3D residual convolution module, and extracting, by the extraction module, a first feature map matrix of at least one target object of the image to be segmented comprises:
extracting, by the convolution module, a feature map matrix of at least one target object of the image to be recognized; and
extracting, by the 3D residual convolution module, the feature map matrix of each target object to obtain a first feature map matrix of at least one target object of the image to be recognized.

5-8. (canceled)
